(19) United States
(12) Patent Application Publication
(10) Pub. No.: US 2026/0002835 A1
(43) Pub. Date: Jan. 1, 2026

(54) OPTICAL WINDOW INSPECTION APPARATUS AND LASER RADAR APPARATUS

(71) Applicant: DENSO WAVE INCORPORATED, Chita-gun, Aichi-pref. (JP)

(72) Inventor: Eiichi SUEYOSHI, Chita-gun (JP)

(73) Assignee: DENSO WAVE INCORPORATED, Chita-gun, Aichi-pref. (JP)

(21) Appl. No.: 18/880,701

(22) PCT Filed: Jun. 28, 2023
(86) PCT No.: PCT/JP2023/024082

§ 371 Date: Jan. 2, 2025

(30) Foreign Application Priority Data
Jul. 13, 2022 (JP) 2022-112346

(51) Int. Cl. G01M 11/02

(52) U.S. Cl. CPC G01M 11/0278; G01M 11/0214

(57) ABSTRACT

An optical window inspection apparatus including: a first light projector that emits first detection light that passes through an optical window transmitting incident light; a second light projector that emits second detection light that does not pass through the optical window; a light receiver that receives the first detection light and the second detection light in which a first voltage corresponding to an intensity of the received first detection light and a second voltage corresponding to an intensity of the received second detection light are generated; and a control unit that corrects a value of the first voltage based on a value of the second voltage and a predetermined reference value and performs processing to detect contamination of the optical window based on a corrected value of the first voltage.

### TECHNICAL FIELD

The present disclosure relates to an optical window inspection apparatus and a laser radar apparatus.

### BACKGROUND ART

PTL 1 presents a detection apparatus for detecting contamination of an optical window, in a scanning distance measuring apparatus that irradiates an object with measurement light thorough an optical window and measures a distance from the object based on information of the measurement light and reflected light from the object. The detection apparatus is arranged in the casing of the scanning distance measuring apparatus. The detection apparatus is arranged on the outer side of the scanning distance measuring apparatus than the optical window provided the casing. A recursive reflection material is arranged in the casing and reflects light. Detection light is emitted from a light emitting element of the detection apparatus toward the optical window. The emitted detection light passes through the optical window and enters the recursive reflection material. The reflected light from the recursive reflection material passes through the optical window. Then, the reflected light is received by a light receiving element of the detection apparatus. The detection apparatus detects contamination attached to the optical window based on the light amount of the reflected light (i.e. reflected detection light) received by the light receiving element.

### CITATION LIST

### Patent Literature

PTL 1: JP 2008-164477 A

### SUMMARY OF THE INVENTION

However, failures in the detection of contamination of the optical window may occur in a conventional technology. For example, detection by the detection apparatus may fail due to the temperature change of the detection apparatus. It is known that the emitted light intensity of a light emitting diode used as the light emitting element and the output voltage of a photodiode used as the light receiving element are dependent on temperature. In the technology of PTL 1, the light emitting intensity of the light emitting diode and the output voltage of the photodiode change with the change in the temperature of an environment in which the scanning distance measuring apparatus is arranged, so that the output voltage may deviate from the estimated voltage. In a case where the output voltage is lower than the estimated voltage, contamination of the optical window is sometimes detected by the detection apparatus in spite of the fact that there is no contamination of the optical window. That is, false detection may occur. On the other hand, in a case where the output voltage is higher than the estimated voltage, contamination of the optical window is sometimes not detected by the detection apparatus in spite of the fact that there is contamination of the optical window. That is, non-detection may occur. Therefore, there is demand for a detection apparatus that can reduce failures in the detection of contamination of the optical window (i.e. the occurrence of false detection and non-detection).

According to an embodiment of the present disclosure, an optical window inspection apparatus is provided. The optical window inspection apparatus includes: a first light projector that emits first detection light that passes through an optical window transmitting incident light; a second light projector that emits second detection light that does not pass through the optical window; a light receiver that receives the first detection light and the second detection light in which a first voltage corresponding to an intensity of the received first detection light and a second voltage corresponding to an intensity of the received second detection light are generated; and a control unit that corrects a value of the first voltage based on a value of the second voltage and a predetermined reference value and performs processing to detect contamination of the optical window based on a corrected value of the first voltage.

According to the optical window inspection apparatus of this embodiment, the second detection light is received by the light receiver without passing through the optical window. Therefore, the value of the second voltage is not influenced by contamination of the optical window. That is, influence by other than contamination of the optical window can be detected based on the value of the second voltage and the reference value. Accordingly, by performing processing to detect contamination of the optical window based on the value of the first voltage corrected based on the value of the second voltage and the reference value, failures in the detection of contamination of the optical window can be reduced even if influence by other than contamination of the optical window occurs in the optical window inspection apparatus. For example, even in a case where the temperature of an environment in which the optical window inspection apparatus is arranged changes, the occurrence of the false detection and non-detection of contamination of the optical window can be reduced in the optical window inspection apparatus.

### BRIEF DESCRIPTION OF THE DRAWINGS

FIG. 1 is a schematic diagram for explaining a part of a laser radar apparatus according to a first embodiment of the present disclosure.

FIG. 2 is a diagram for explaining a difference in received light intensity of a second light receiver and a difference in corrected received light intensity of a first light receiver.

FIG. 3 is a schematic diagram for explaining a state in which an optical window is not positioned in a predetermined range.

FIG. 4 is a schematic diagram for explaining a configuration of a laser radar apparatus according to a second embodiment of the present disclosure.

FIG. 5 is a block diagram illustrating an example of a hardware configuration of a control unit according to an embodiment of the present disclosure.

### DESCRIPTION OF THE EMBODIMENTS

### A. First Embodiment

### A1. Configuration of First Embodiment

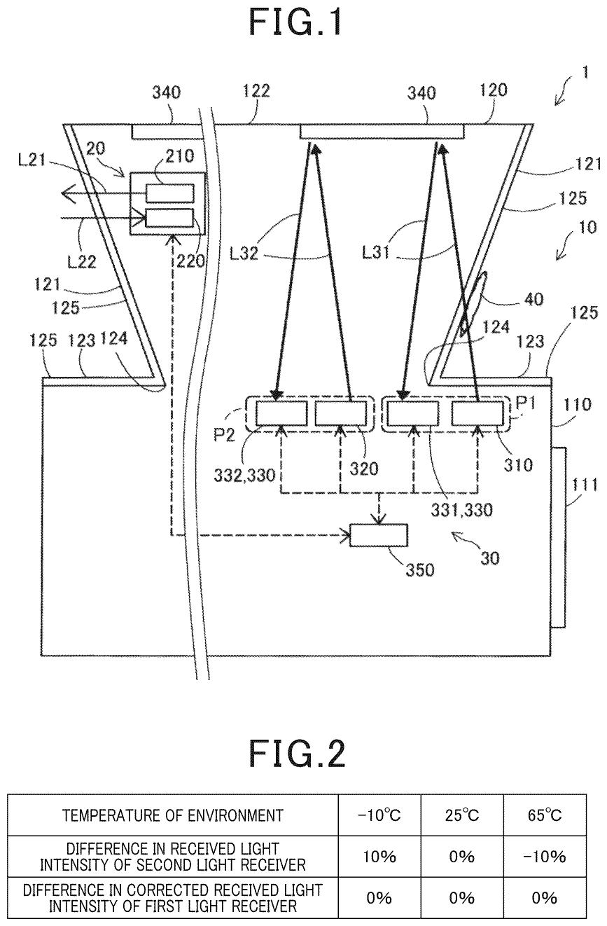

FIG. 1 is a schematic diagram for explaining a part of a laser radar apparatus 1 according to a first embodiment of the present disclosure. FIG. 1 illustrates a cross section of the laser radar apparatus 1, but hatching to be included in the cut surface is omitted. The laser radar apparatus 1 emits measurement light, receives reflected light from an object irradiated with the measurement light, and measures a distance between the laser radar apparatus 1 and the object based on the reflected light. The laser radar apparatus 1 includes a case 10, a distance measuring unit 20, and a detection unit 30 (i.e. an optical window inspection apparatus). In FIG. 1, contamination 40 is attached to the case 10. Power is supplied from an unillustrated power source to the distance measuring unit 20 and the detection unit 30.

The case 10 includes components of the laser radar apparatus 1. The case 10 houses the distance measuring unit 20 and the detection unit 30. The case 10 includes a first case body 110 and a second case body 120.

The first case body 110 houses constituent elements of the detection unit 30 other than a reflector 340. Specifically, the first case body 110 houses a first light projector 310, a first light receiver 331, a second light projector 320, a second light receiver 332, and a control unit 350. The shape of the first case body 110 is a substantially rectangular parallelepiped in which one plane opens. The first case body 110 further includes a monitor 111 on the outside thereof.

The monitor 111 displays various screens such as a setting screen and an operation screen based on a display signal input from the control unit 350. In the present embodiment, the monitor 111 is controlled by the control unit 350 and displays that an optical window 125 has contamination. The monitor 111 may be, for example, a liquid crystal display (LCD), an electroluminescence display (ELD), or the like.

The second case body 120 houses the distance measuring unit 20 and the reflector 340 of the detection unit 30. The second case body 120 is connected with the first case body 110. The second case body 120 includes a side surface 121, an upper surface 122, and a flange 123. The second case body 120 has such a shape that the upper base of a substantially circular truncated cone turned upside down opens with a flange disposed to the upper base.

The side surface 121 is formed of the optical window 125 that transmits light. For example, the side surface 121 transmits measurement light L21 of the distance measuring unit 20, reflected light L22, and first detection light L31 of the detection unit 30. The side surface 121 corresponds to the side surface of the substantially circular truncated cone. The upper surface 122 corresponds to the lower base of the substantially circular truncated cone. The upper surface 122 is connected with the side surface 121. The reflector 340 is arranged to the upper surface 122.

The flange 123 is formed of the optical window 125 that transmits light. For example, the flange 123 transmits the first detection light L31 of the detection unit 30. The flange 123 is connected with the first case body 110. Accordingly, the side surface 121, the upper surface 122, and the flange 123 (i.e. the second case body 120) seal the opening of the first case body 110. That is, the inside of the first case body 110 communicates with the inside of the second case body 120. The flange 123 extends from an edge 124 of the opening surface corresponding to the upper base of the substantially circular truncated cone to the outside of the second case body 120. The flange 123 is a plate-like part. It also can be said that the flange 123 and the side surface 121 are constituted by the optical window 125.

The optical window 125 transmits incident light. For example, the optical window 125 transmits the measurement light L21 emitted from a measurement light source 210 of the distance measuring unit 20, the reflected light L22, and the first detection light L31 emitted by the first light projector 310 of the detection unit 30. The distance measuring unit 20 described later is arranged to be surrounded by the optical window 125.

In the present embodiment, the optical window 125 is dismantlable in the laser radar apparatus 1. Specifically, it is possible to separate the second case body 120 including the optical window 125 from the first case body 110. The dismantling of the optical window 125 will be described later.

The distance measuring unit 20 uses the measurement light L21 to measure a distance to an object that reflects the measurement light L21. The distance measuring unit 20 is housed in the second case body 120. The distance measuring unit 20 is rotatable around the central axis of the substantially circular truncated cone portion of the second case body 120. In FIG. 1, the central axis is omitted. The position of the distance measuring unit 20 in the second case body 120 is not limited to the position in FIG. 1. The distance measuring unit 20 is controlled by the control unit 350. The distance measuring unit 20 includes the measurement light source 210 and a measurement light receiving unit 220.

The measurement light source 210 emits measurement light L21 toward the optical window 125 according to the control of the control unit 350. The emitted measurement light L21 passes through the optical window 125. The measurement light L21 having passed through the optical window 125 arrives at an unillustrated object. The measurement light source 210 may be, for example, a semiconductor laser. The measurement light receiving unit 220 receives reflected light L22 reflected from the object and passing through the optical window 125. As described above, the distance measuring unit 20 is rotatable around the central axis of the substantially circular truncated cone portion of the second case body 120. Therefore, the distance measuring unit 20 can emit the measurement light L21 in various directions and receive the reflected light L22 from an object in various directions. The measurement light receiving unit 220 is, for example, a photodiode. Hereinafter, a photodiode is called a PD.

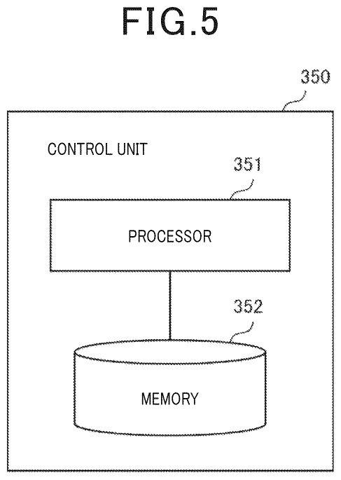

The detection unit 30 detects contamination of the optical window 125. The detection unit 30 includes seven first light projectors 310, a second light projector 320, a light receiver 330, a reflector 340, and a control unit 350. In FIG. 1, one of the seven first light projectors 310 is shown. As shown in FIG. 5, the control unit 350 may be implemented by, for example, a processor 351 such as a central processing unit (CPU) or a micro processing unit (MPU) and a memory 352 such as a random-access memory (RAM) or a read only memory (ROM).

The first light projector 310 emits first detection light L31 that passes through the optical window 125. The first light projector 310 is housed in the first case body 110. In the present embodiment, the first light projector 310 may be a light emitting diode (hereinafter, referred to as an LED). The second light projector 320 emits second detection light L32 that does not pass through the optical window 125. The second light projector 320 is housed in the first case body 110. In the present embodiment, the second light projector 320 may be an LED.

The light receiver 330 receives the first detection light L31 and the second detection light L32 reflected by the reflector 340. In the light receiver 330, a voltage corresponding to the intensity of the received first detection light L31 and a voltage corresponding to the intensity of the received second detection light L32 are generated. The voltages generated in the light receiver 330 are also referred to as output voltages. The light receiver 330 includes seven first light receivers 331 and one second light receiver 332. In FIG. 1, one of the seven first light receivers 331 is shown.

The first light receiver 331 receives the first detection light L31 reflected by the reflector 340. In the first light receiver 331, a voltage corresponding to the intensity of the received first detection light L31 is generated. The first light receiver 331 may be a PD. Each of the seven first light receivers 331 is combined with each of the corresponding seven first light projectors 310. That is, the first detection light L31 emitted by one of the seven first light projectors 310 is received by the corresponding one of the seven first light receivers 331. There are seven combinations of the first light projector 310 and the first light receiver 331. A combination of the first light projector 310 and the first light receiver 331 is called a first pair P1. In FIG. 1, one first pair P1 is shown.

The first pair P1 is housed in the first case body 110. The first pair P1 is arranged in such a position as to allow first detection light L31 to enter the reflector 340 and receive the first detection light L31 reflected by the reflector 340. The first light projector 310 and the first light receiver 331 of the first pair P1 are close to each other. For example, the distance between the first light receiver 331 and the second light receiver 332 may be 1 to 2 cm. The seven first pairs P1 are annularly arranged at equal intervals along the edge 124 of the flange 123 of the optical window 125 in the first case body 110. For example, the first pairs P1 are arranged along the circular sector arc around the center axis of the second case body 120, and the arrangement intervals are an angle of 40 degrees.

The second light receiver 332 receives the second detection light L32 reflected by the reflector 340. In the second light receiver 332, a voltage corresponding to the intensity of the received second detection light L32 is generated. The second light receiver 332 may be a PD. The second light receiver 332 is combined with the second light projector 320. That is, the second detection light L32 emitted by the second light projector 320 is received by the second light receiver 332. A combination of the second light projector 320 and the second light receiver 332 is called a second pair P2.

The second pair P2 is housed in the first case body 110. The second pair P2 is arranged in such a position as to allow second detection light L32 to enter the reflector 340 and receive the reflected second detection light L32. The second light projector 320 and the second light receiver 332 of the second pair P2 are close to each other. For example, the distance between the second light projector 320 and the second light receiver 332 may be 1 to 2 cm. The second pair P2 is close to the first pair P1. For example, the distance between the second pair P2 and each of the first pairs P1 is 1 to 2 cm. The distance between the second pair P2 and the first pair P1 is a linear distance between the first light receiver 331 and the second light projector 320. Since the seven first light receivers 331 and the one second light receiver 332 are close to each other in the first case body 110, the temperatures of environments in which these are arranged are substantially identical. In other words, the seven first light receivers 331 and the one second light receiver 332 are arranged such that the temperatures of environments in which they are arranged are substantially identical. The light receiver 330 includes the first light receiver 331 and the second light receiver 332, thereby the flexibility of the arrangement of the light receiver 330 in the case 10 is higher than in a case where one light receiving element (i.e. a light receiver) receives the first detection light L31 and the second detection light L32. Further, the processing of the control unit 350 can be more simplified than in the above-described case. For example, in a case where one light receiver receives two detection lights, it is necessary to distinguish between the detection lights received by the light receiver in order to measure an output voltage of each detection light. Therefore, the control unit 350 is required to, for example, control the light emitting timings of detection lights. However, according to the detection unit 30 of the present embodiment, multiple light receivers receive their corresponding detection lights, so that there is no requirement for the above-described processing to distinguish between detection lights (for example, processing to control the light emitting timings of detection lights).

The reflector 340 reflects the first detection light L31 having passing through the optical window 125 and the second detection light L32 not passing through the optical window 125. The reflector 340 is arranged on the upper surface 122 of the second case body 120 inside the second case body 120. For example, the shape of the reflector 340 is an annular sector. The central angle of the reflector 340 may be 270 degrees. The center of the arc of the reflector 340 coincides with the center of the second case body 120 (i.e. the upper surface 122).

Since the reflector 340 is disposed in the present embodiment, the degree of freedom in the optical path of the first detection light L31 and the second detection light L32 is higher than in a case where there is not the reflector 340.

Further, since the reflector 340 is arranged on the upper surface 122 opposite the opening surface of the second case body 120, attachment of external contamination to the reflector 340 can be avoided when dismantling the second case body 120. In addition, since the shape of the reflector 340 is an annular sector, the reflector 340 can singly reflect the plurality of first detection lights L31 emitted by the plurality of first pairs P1 arranged annularly.

As described above, constituent elements of the detection unit 30 other than the reflector 340 are housed in the first case body 110. As compared to in a case where constituent elements of the detection unit 30 other than the reflector 340 are decentrally housed in both the first case body 110 and the second case body 120, the power system for supplying power to the detection unit 30 is consolidated in the first case body 110. This can reduce the size of the laser radar apparatus 1.

An optical path via the reflector 340 will be described. First detection light L31 emitted by the first light projector 310 of the first pair P1 enters the reflector 340. The first detection light L31 having entered the reflector 340 is reflected by the reflector 340. The reflected first detection light L31 is received by the first light receiver 331. Second detection light L32 emitted from the second light projector 320 of the second pair P2 enters the reflector 340. The second detection light L32 having entered the reflector 340 is reflected by the reflector 340. The reflected second detection light L32 is received by the second light receiver 332.

The control unit 350 detects contamination of the optical window 125 based on the value of the output voltage of the light receiver 330. Specifically, the control unit 350 corrects the value of the output voltage of the first detection light L31 based on the difference between the value of the output voltage of the second detection light L32 and a predetermined reference value. The control unit 350 detects contamination of the optical window 125 based on the corrected value of the output voltage of the first detection light L31. Details of the correction will be described later.

In the present embodiment, the control unit 350 calculates the distance between the laser radar apparatus 1 and an object based on the reflected light L22 received by the distance measuring unit 20. As described above, the measurement light L21 emitted by the measurement light source 210 passes through the optical window 125 and exits the laser radar apparatus 1. The measurement light L21 is reflected by the object, and reflected light L22 as the reflected measurement light passes through the optical window 125 and is received by the measurement light receiving unit 220. A phase difference occurs between the emitted measurement light L21 and the received reflected light L22 due to the passage of time from when the measurement light L21 is emitted to when the reflected light L22 is received by the measurement light receiving unit 220. The control unit 350 calculates the distance based on the phase difference.

### A2. Correction of Value of Output Voltage of First Detection Light L31 and Detection of Contamination of Optical Window 125 by Control Unit 350

It is known that an output from an LED or a PD is dependent on the temperature of an environment in which the LED or the PD is arranged. For example, the intensity of light emitted by an LED decreases with the increase in the temperature of an environment. The voltage (i.e. output voltage) generated in a PD increases with the increase in the temperature of an environment. In addition, the inventor found that in a case where a specific LED is used as the light source, and a specific PD is used as the light receiving element, the value of the output voltage of the PD decreases with the increase int the temperature of an environment. The inventor also found that the value of the output voltage of a PD increases with the decrease in the temperature of an environment.

In the present embodiment, a combination of an LED and a PD in which the correlation between the temperature and the output voltage is negative is selected. The LEDs used as the first light projector 310 and the second light projector 320 have substantially identical characteristics for temperature. The PDs used as the first light receiver 331 and the second light receiver 332 have substantially identical characteristics for temperature.

The correction of the value of the output voltage of the first detection light L31 by the control unit 350 in the present embodiment will be described. In the present embodiment, the value of the output voltage of the second light receiver 332 having received the detection light emitted by the second light projector 320 with a predetermined intensity in a state in which the laser radar apparatus 1 is arranged in the environment at 25° C. is stored, as a predetermined reference value at a received light intensity of 100%, in the control unit 350 by a user.

FIG. 2 is a diagram for explaining a difference in the received light intensity of the second light receiver 332 and a difference in the corrected received light intensity of the first light receiver 331. FIG. 2 illustrates a difference between the received light intensity at each temperature and the received light intensity at 25° C., with the received light intensity at 25° C. as a reference. Specifically, FIG. 2 illustrates a difference between the received light intensity of an environment at −10° C. or an environment at 65° C. and the received light intensity at 25° C. The difference of the received light intensity of the second light receiver 332 is a difference between the received light intensity of the second light receiver 332 at each temperature and the received light intensity of the second light receiver 332 at 25° C. (i.e. the received light intensity corresponding to the reference value). As described above, the first light receiver 331 and the second light receiver 332 have substantially identical characteristics for temperature. Therefore, the difference of the received light intensity of the second light receiver 332 can be considered as the difference between the received light intensity of the first light receiver 331 at each temperature and the received light intensity of the first light receiver 331 at 25°° C. The difference in the corrected received light intensity of the first light receiver 331 is a difference between the received light intensity of the first light receiver 331 corresponding to the corrected output voltage at each temperature and the received light intensity of the second light receiver 332 at 25° C. (i.e. the received light intensity of the first light receiver 331 at 25° C.).

Hereinafter, the correction for the environment at 65° C. by the control unit 350 will be described. As shown in FIG. 1, the second light projector 320 emits second detection light L32 in response to the instruction of the control unit 350, and the second light receiver 332 receives the second detection light L32. In the second light receiver 332, an output voltage corresponding to the intensity of the received second detection light L32 is generated. The control unit 350 calculates the received light intensity of the second light receiver 332 from the value of the output voltage generated in the second light receiver 332 and the predetermined reference value. For example, as shown in FIG. 2, the received light intensity (i.e. 90%) of the second light receiver 332 in the environment at a temperature of 65° C. is calculated, and the received light intensity is smaller by 10% than the received light intensity (i.e. 100%) of the second light receiver 332 at 25° C. At this time, the received light intensity of the first light receiver 331 is also considered as being smaller by 10% than the received light intensity of the second light receiver 332 at 25° C.

Next, the first light projector 310 emits first detection light L31 in response to the instruction of the control unit 350, and the first light receiver 331 receives the first detection light L31 (see FIG. 1). It is noted that the timing at which the first light receiver 331 receives the first detection light L31 (i.e. the timing at which the first light projector 310 emits first detection light L31) and the timing at which the second light receiver 332 receives the second detection light L32 (i.e. the timing at which the second light projector 320 emits second detection light L32) may be different or the same.

Here, a case in which correction is not performed is assumed. As described above, the received light intensity of the first light receiver 331 in the environment at 65° C. is lower by 10% than in the environment at 25° C. In this case, the control unit 350 may detect contamination of the optical window 125 due to the decrease in received light intensity caused by high temperature, even when the optical window 125 has no contamination. As a result, for example, a user may be required to perform unnecessary cleaning of the optical window 125 according to the notification based on the instruction of the control unit 350.

The correction of the value of the output voltage of the first detection light L31 will be described. Specifically, the control unit 350 multiplies a numerical value obtained by dividing the received light intensity corresponding to the predetermined reference value by the received light intensity of the second detection light L32, by the value of the output voltage of the first detection light L31. For example, the control unit 350 multiplies a value obtained by dividing 100% as the received light intensity corresponding to the predetermined reference value by 90% as the received light intensity of the second light receiver 332, by the value of the output voltage of the first detection light L31. This corrects the value of the output voltage of the first detection light L31 for the decrease of 10%. In this manner, the value of the output voltage of the first detection light L31 in the environment at 65° C. is corrected. The control unit 350 detects contamination of the optical window 125 based on the corrected value of the output voltage of the first detection light L31. Specifically, the control unit 350 detects contamination of the optical window 125 based on the ratio between the corrected value of the output voltage of the first detection light L31 and the predetermined reference value.

Next, the correction in the environment at −10° C. by the control unit 350 will be described. As shown in FIG. 2, the received light intensity of the second light receiver 332 in the environment at −10° C. is larger by 10% than the received light intensity of the second light receiver 332 at 25° C. The control unit 350 corrects the value of the output voltage of the first detection light L31 based on the value of the output voltage of the second light receiver 332 and the reference value, as in the above-described correction in the environment at 65° C. Note that when the received light intensity (i.e. output voltage) becomes excessively high, the control unit 350 may determine that the laser radar apparatus 1 is not operating normally and terminate the operation of the laser radar apparatus 1. Although examples at −10° C. and 65° C. are shown in FIG. 2, the temperature at which correction is possible is not limited to these temperatures. The correction is possible in a temperature range wider or narrower than the range containing these temperatures.

Note that the difference in the corrected received light intensity of the first light receiver 331 at each temperature is 0% in FIG. 2, but the difference in the corrected received light intensity of the first light receiver 331 may be a numerical value other than 0% due to the environment in which the first light receiver 331 and the second light receiver 332 are arranged as well as the characteristics of a PD. In that case, the control unit 350 may perform additional correction. For example, in a case where the corrected received light intensity of the first light receiver 331 at 65° C. is +3%, +3% is stored as an additional correction value in the control unit 350 by a user. The control unit 350 uses the stored additional correction value to correct the value of the output voltage of the first detection light L31 such that +3% becomes 0%. The additional correction may be performed at the same time as the above-described correction attributable to temperature.

In the present embodiment, the second detection light L32 is received by the light receiver 330 without passing through the optical window 125. Therefore, the value of the output voltage of the second detection light L32 is not influenced by contamination of the optical window 125. Contamination of the optical window 125 is detected based on the value of the output voltage of the first detection light L31 corrected based on the value of the output voltage of the second detection light L32 and the predetermined reference value. This can reduce occurrence of false detection and non-detection of contamination of the optical window 125 in the laser radar apparatus 1 even in a case where the temperature of an environment in which the laser radar apparatus 1 is arranged changes. As a result, erroneous measurement of the distance between the laser radar apparatus 1 and an object by the distance measuring unit 20 can be suppressed. Further, unnecessary cleaning of the optical window 125 required of a user by notification based on the instruction of the control unit 350 can be suppressed.

In the present embodiment, contaminations in different positions in the optical window 125 are detected by the plurality of first pairs P1. Therefore, as compared to in a case where the laser radar apparatus 1 includes only one first pair P1, contaminations in a plurality of positions of the optical window 125 can be detected. This suppresses erroneous measurement of distances in a plurality of directions when the distance measuring unit 20 measures distances in a plurality of directions.

### A3. Display Indicating That Optical Window 125 Has Contamination

In the present embodiment, the control unit 350 causes the monitor 111 to display that the optical window 125 has contamination in a case where the corrected value of the output voltage of the first detection light L31 is smaller than the predetermined numerical value. In other words, the control unit 350 outputs a detected signal of contamination of the optical window 125 in a case where the corrected value of the output voltage of the first detection light L31 is smaller than the threshold. The predetermined numerical value is an optional numerical value stored in the control unit 350 by a user. In a case where the corrected value of the output voltage of the first detection light L31 is smaller than this numerical value, the control unit 350 causes the monitor 111 to output a screen for warning that cleaning of the optical window 125 by a user is necessary. Accordingly, a user can realize the timing of cleaning of the optical window 125.

### A4. Detection of Dismantling of Optical Window 125

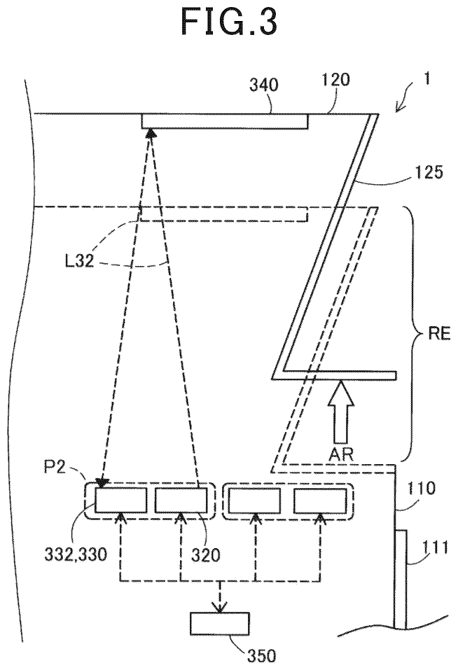

FIG. 3 is a schematic diagram for explaining a state in which the optical window 125 is not positioned in a predetermined range RE. In the present embodiment, the control unit 350 can utilize the second pair P2 to detect that the optical window 125 is not positioned in the predetermined range RE. The second case body 120 provided with the optical window 125 can be separated from the first case body 110 by a user for replacement or cleaning. That is, the second case body 120 is detachable from the first case body 110. For example, the second case body 120 is separated as shown by arrow AR in FIG. 3. However, there is a possibility that the second case body 120 may be separated from the first case body 110 without the intention of a user.

When the second case body 120 is separated from the first case body 110, the value of the output voltage of the second detection light L32 reflected by the reflector 340 decreases. In the present embodiment, the control unit 350 outputs that the optical window 125 is not positioned in the predetermined range RE when the value of the output voltage of the second detection light L32 is smaller than the predetermined threshold. The predetermined threshold is the minimum value of the value of the output voltage generated in the second light receiver 332 receiving the second detection light L32. The predetermined range RE is, for example, a range from the bottom end (e.g. the flange 123) to the upper end (e.g. the upper surface 122) of the optical window 125 in a state in which the second case body 120 is connected with the first case body 110.

For example, the control unit 350 outputs an error signal to the monitor 111 in a case where the value of the output voltage of the second detection light L32 is smaller than the predetermined threshold. That is, the control unit 350 detects that the optical window 125 is dismantled. The monitor 111 displays that the optical window 125 is not positioned in the predetermined range RE based on the error signal. Accordingly, a user can realize that the optical window 125 is not positioned in the predetermined range RE. That is, a user can realize that the second case body 120 is separated from the first case body 110.

### B. Second Embodiment

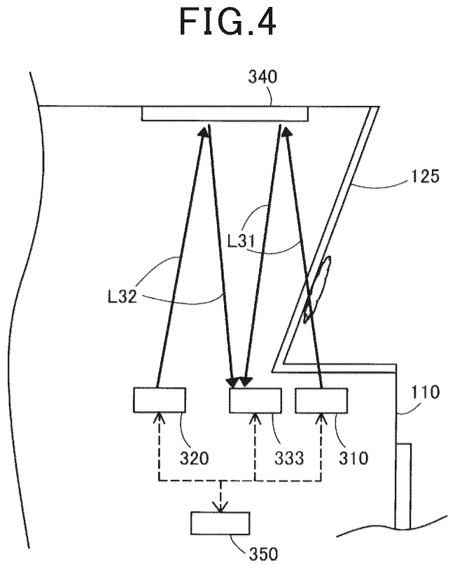

FIG. 4 is a schematic diagram for explaining a configuration of a laser radar apparatus 1 according to a second embodiment. In the second embodiment, one light receiver receives the first detection light L31 and the second detection light L32, unlike in the first embodiment. Since other configuration and processing are similar to those of the first embodiment, the same reference signs are assigned, and detailed description will be omitted.

As shown in FIG. 4, the laser radar apparatus 1 in the present embodiment includes seven first light projectors 310, one second light projector 320, and seven light receivers 333. Each of the light receivers 333 operates as the light receiver 330. In the first embodiment, the first light receiver 331 receives the first detection light L31, and the second light receivers 332 receives the second detection light L32. In the second embodiment, the light receiver 333 receives the first detection light L31 and the second detection light L32 as shown in FIG. 4. The second detection light L32 may be received by any of the seven light receivers 333.

In the second embodiment, the control unit 350 controls the light receiver 333 to receive the first detection light L31 and the second detection light L32 at different timings. First, the control unit 350 causes the second light projector 320 to emit light, second detection light L32 is received by the light receiver 333, and an output voltage is generated in the light receiver 333. The control unit 350 stores the value of the output voltage generated in the light receiver 333. Next, the control unit 350 causes the first light projector 310 to emit light, first detection light L31 is received by the light receiver 333, and an output voltage is generated in the light receiver 333. The control unit 350 corrects the output voltage of the first detection light L31 based on the stored output voltage of the second detection light L32 and the reference value. Since the correction processing is the same as that in the first embodiment, the description will be omitted. Accordingly, contamination of the optical window 125 is detected by the control unit 350 in the same manner as in the first embodiment.

In this manner, according to the second embodiment, the constituent elements of the laser radar apparatus 1 can be reduced, and the size of the laser radar apparatus 1 is decreased, as compared to in a case where the first detection light L31 and the second detection light L32 are received by separate light receivers like in the first embodiment.

### C. Other Embodiments

(C1-1) In the above-described embodiment, the value of the output voltage corresponding to the received light intensity of the second light receiver 332 in the environment at 25° C. is stored as the predetermined reference value in the control unit 350 by a user. However, the value of the output voltage corresponding to the received light intensity at a temperature other than 25° C., such as 27° C. or 30° C., may be used as the predetermined reference value, depending on the characteristics of the first light projector 310, the second light projector 320, and the light receiver 330.
(C1-2) The value of the output voltage corresponding to the received light intensity measured in a state in which the second light projector 320 and the light receiver 330 are arranged outside the laser radar apparatus 1 may be used as the predetermined reference value.
(C1-3) In the above-described embodiment, the control unit 350 corrects the value of the output voltage of the first detection light L31 based on the ratio between the value of the output voltage of the second detection light L32 and the predetermined reference value. However, the control unit 350 may correct the value of the output voltage of the first detection light L31 based on the difference between the value of the output voltage of the second detection light L32 and the predetermined reference value.
(C1-4) In the above-described embodiment, the control unit 350 detects contamination of the optical window 125 based on the difference between the corrected value of the output voltage of the first detection light L31 and the value of the output voltage of the second detection light L32 at 25° C. However, the control unit 350 may detect contamination of the optical window 125 based on the difference between the corrected value of the output voltage of the first detection light L31 and the value of the output voltage of the first detection light L31 at 25° C. The value of the output voltage of the first detection light L31 at 25° C. is measured in a state in which the optical window 125 has no contamination, and previously stored in the control unit 350.
(C1-5) In the above-described embodiment, an LED is used as the first light projector 310 and the second light projector 320, and a PD is used as the first light receiver 331 and the second light receiver 332. However, a light source other than an LED may be used as the first light projector 310 and the second light projector 320. For example, the light source other than an LED may be a super luminescent diode (SLD), a laser diode (LD), or an infrared light source. Further, the light receiving element of the light receiver 330 may be an avalanche photodiode. The reference value is set corresponding to the characteristics for temperature of each combination of the light source and the light receiving element, thereby the output voltage of the first detection light L31 can be corrected corresponding to the characteristics.
(C1-6) An optical window inspection apparatus including the detection unit 30 and the case 10 excluding the distance measuring unit 20 may be formed.
(C2-1) In the above-described embodiment, the laser radar apparatus 1 includes seven first light projectors 310 and seven first light receivers 331. However, the number of first light projectors 310 and the number of first light receivers 331 each may be one and may be other than seven, such as four or five. The laser radar apparatus 1 can include a plurality of first light projectors 310 and a plurality of first light receivers 331. Further, the number of first light projectors 310 and the number of first light receivers 331 may be different. The plurality of first light projectors 310 and the plurality of first light receivers 331 may not be partly used.
(C2-2) In the above-described embodiment, the distance between the first light projector 310 and the first light receiver 331 is 1 to 2 cm, the distance between the second light projector 320 and the second light receiver 332 is 1 to 2 cm, and the distance between the second pair P2 and each of the first pairs P1 is 1 to 2 cm. However, these distances may be a distance different from 1 to 2 cm, such as 0. 5 cm, 3 cm, or 5 cm. The first light receiver and the second light receiver are arranged to adjoin each other in the first case body 110 such that the temperature of an environment in which the first light receiver is arranged is substantially the same as the temperature of an environment in which the second light receiver is arranged.
(C3-1) In the above-described embodiment, the control unit 350 corrects the value of the output voltage of the first detection light L31, and utilizes the value of the corrected output voltage to detect contamination of the optical window 125. However, the control unit 350 may correct the threshold used in the processing to detect contamination of the optical window 125, and utilize the corrected threshold to detect contamination of the optical window 125. Specifically, the control unit 350 corrects the threshold used in the processing to detect contamination of the optical window 125 based on the value of the output voltage of the second detection light L32 and the predetermined reference value, and detects contamination of the optical window 125 based on the value of the output voltage of the first detection light L31 and the corrected threshold. For example, the threshold used in the contamination detection processing is the predetermined numerical value described in the above-described A3. Even in a case where the threshold used in the contamination detection processing is corrected instead of correcting the value of the output voltage of the first detection light L31 in this manner, the same effect can be provided.
(C4-1) In the above-described embodiment, the detection unit 30 includes the reflector 340. However, the detection unit 30 may not include the reflector 340. In this case, the first light projector 310 and the second light projector 320 emit first detection light L31 and second detection light L32, respectively, toward the light receiver 330. The light receiver 330 directly receives the first detection light L31 and the second detection light L32 from the first light projector 310 and the second light projector 320, respectively.
(C5-1) In the above-described embodiment, the first case body 110 houses constituent elements of the detection unit 30 other than the reflector 340, and the second case body 120 houses the reflector 340. However, the second case body 120 may house the reflector 340 and the control unit 350, and the first case body 110 may house constituent elements of the detection unit 30 other than the reflector 340 and the control unit 350.
(C5-2) In the above-described embodiment, the shape of the first case body 110 is a substantially rectangular parallelepiped. However, the shape of the first case body 110 may be a shape other than a substantially rectangular parallelepiped, such as a substantially circular cylinder or a substantially triangular prism.
(C5-3) In the above-described embodiment, the shape of a part of the second case body 120 is a substantially circular truncated cone. However, the shape of the part of the second case body 120 may be another shape such as a substantially circular cylinder or a substantially rectangular parallelepiped
(C5-4) In the above-described embodiment, the side surface 121 and the flange 123 of the second case body 120 are formed by the optical window 125. However, only a part of the side surface 121 and a part of the flange 123 of the second case body 120 may be formed by the optical window 125.
(C6-1) In the above-described embodiment, the shape of the reflector 340 is an annular sector with a central angle of 270 degrees. However, the central angle of the reflector 340 may be an angle other than 270 degrees such as 240 degrees or 260 degrees. For example, the shape of the reflector 340 may be an annular sector with a central angle of 180 degrees. Further, the detection unit 30 may include a plurality of reflectors 340. For example, the plurality of reflectors 340 may be seven reflectors having the shape of a substantially rectangular parallelepiped. In a case where the detection unit 30 includes the plurality of reflectors 340, the shapes of the plurality of reflectors 340 may be different from one another. In this case, the first detection light L31 and the second detection light L32 may be reflected by any of the plurality of reflectors 340.
(C7-1) In the above-described embodiment, the optical window 125 is dismantlable. However, the optical window 125 may not be dismantlable by integrally forming the first case body 110 and the second case body 120.
(C7-2) In the above-described embodiment, the control unit 350 outputs that the optical window 125 is not positioned in the predetermined range RE in a case where the value of the output voltage of the second detection light L32 is smaller than the predetermined threshold. However, in a case where the optical window 125 is not dismantlable, the control unit 350 may not determine whether the optical window 125 is positioned in the predetermined range. In this case, it is not performed to output that the optical window 125 is not positioned in the predetermined range.
(C8-1) In the above-described embodiment, the first case body 110 includes the monitor 111. However, the first case body 110 may not include the monitor 111. Further, even in a case where the first case body 110 includes the monitor 111, the control unit 350 may not cause the monitor 111 to display that the optical window has contamination.
(C9-1) In the above-described embodiment, the control unit 350 calculates the distance between the laser radar apparatus 1 and an object based on the phase difference occurring between the measurement light L21 and the reflected light L22. However, the control unit 350 may calculate the distance based on the time from the emitting of the measurement light L21 to the receipt of the reflected light L22. For example, the measurement light source 210 emits measurement light L21 modulated into pulses, and the measurement light receiving unit 220 receives reflected light L22 from the object. The control unit 350 calculates the above-described distance based on the time from the emitting of the measurement light L21 to the receipt of the reflected light L22.
(C9-2) In the above-described embodiment, the control unit 350 controls the distance measuring unit 20 and the detection unit 30. However, the laser radar apparatus 1 may include another control unit other than the control unit 350, and the another control unit may control the distance measuring unit 20.
(C9-3) In the above-described embodiment, the measurement light source 210 is a semiconductor laser, and the measurement light receiving unit 220 is a PD. However, the measurement light source 210 may be a laser other than a semiconductor laser, such as a solid-state laser or a gas laser. The measurement light receiving unit 220 may also be an avalanche photodiode.
(C10-1) In the above-described embodiment, combinations of each of the seven first light projectors 310 and each of the seven first light receivers 331 are aligned at equal intervals along the optical window 125. However, the combinations of each of the seven first light projectors 310 and each of the seven first light receivers 331 may not be aligned at equal intervals. For example, the arrangement interval between certain two combinations may be an angle of 60 degrees, and the arrangement interval between other two combinations may be an angle of 40 degrees.
(C10-2) In the above-described embodiment, the plurality of first pairs P1 are arranged at intervals of an angle of 40 degrees. However, the arrangement intervals between the plurality of first pairs P1 may be an angle other than 40 degrees, such as 30 degrees or 50 degrees.

The present disclosure is not limited to the above-described embodiments, examples, and modification examples, and can be realized in various configurations within the scope that does not depart from the spirit thereof. For example, the above-described embodiments, examples, and modification examples may be partly replaced, combined, or deleted in an appropriate manner, as long as the above-described problem is solved, or the above-described effect is exerted.

1. An optical window inspection apparatus comprising:
a first light projector that emits first detection light that passes through an optical window transmitting incident light;
a second light projector that emits second detection light that does not pass through the optical window;
a light receiver that receives the first detection light and the second detection light, in which a first voltage corresponding to an intensity of the received first detection light and a second voltage corresponding to an intensity of the received second detection light are generated; and
a control unit that corrects a value of the first voltage based on a value of the second voltage and a predetermined reference value and performs processing to detect contamination of the optical window based on a corrected value of the first voltage.

2. The optical window inspection apparatus according to claim 1, wherein the light receiver includes a first light receiver and a second light receiver,
the first light receiver receives the first detection light, and the first voltage is generated in the first light receiver, and
the second light receiver receives the second detection light, and the second voltage is generated in the second light receiver.

3. The optical window inspection apparatus according to claim 1, wherein
the light receiver includes a single light receiver, and
the first light projector emits the first detection light at a timing different from a timing at which the second light projector emits the second detection light.

4. The optical window inspection apparatus according to claim 1, further comprising a reflector that reflects light,
wherein the light receiver receives the first detection light reflected by the reflector and the second detection light reflected by the reflector.

5. The optical window inspection apparatus according to claim 4, wherein
the first light projector, the second light projector, the light receiver, and the control unit are housed in a first case body,
the reflector is housed in a second case body provided with the optical window,
the first case body is connected with the second case body, and
an inside of the first case body communicates with an inside of the second case body.

6. The optical window inspection apparatus according to claim 1,
wherein the control unit outputs an error signal regarding a position of the optical window in a case where a value of the second voltage is smaller than a predetermined threshold.

7. The optical window inspection apparatus according to claim 1,
wherein the control unit outputs a detected signal of contamination of the optical window in a case where a corrected value of the first voltage is smaller than a predetermined threshold.

8. A laser radar apparatus comprising:
the optical window inspection apparatus according to claim 1;
a case provided with the optical window; and
a distance measuring unit that emits measurement light that passes through the optical window, and receives reflected light of the measurement light,
wherein the case houses the optical window inspection apparatus and the distance measuring unit.

9. The optical window inspection apparatus according to claim 2, further comprising a reflector that reflects light,
wherein the light receiver receives the first detection light reflected by the reflector and the second detection light reflected by the reflector.

10. The optical window inspection apparatus according to claim 3, further comprising a reflector that reflects light,
wherein the light receiver receives the first detection light reflected by the reflector and the second detection light reflected by the reflector.

11. The optical window inspection apparatus according to claim 2,
wherein the control unit outputs an error signal regarding a position of the optical window in a case where a value of the second voltage is smaller than a predetermined threshold.

12. The optical window inspection apparatus according to claim 3,
wherein the control unit outputs an error signal regarding a position of the optical window in a case where a value of the second voltage is smaller than a predetermined threshold.

13. The optical window inspection apparatus according to claim 2,
wherein the control unit outputs a detected signal of contamination of the optical window in a case where a corrected value of the first voltage is smaller than a predetermined threshold.

14. The optical window inspection apparatus according to claim 3,
wherein the control unit outputs a detected signal of contamination of the optical window in a case where a corrected value of the first voltage is smaller than a predetermined threshold.

15. A laser radar apparatus comprising:
the optical window inspection apparatus according to claim 2;
a case provided with the optical window; and
a distance measuring unit that emits measurement light that passes through the optical window, and receives reflected light of the measurement light,
wherein the case houses the optical window inspection apparatus and the distance measuring unit.

16. A laser radar apparatus comprising:
the optical window inspection apparatus according to claim 3;
a case provided with the optical window; and
a distance measuring unit that emits measurement light that passes through the optical window, and receives reflected light of the measurement light,
wherein the case houses the optical window inspection apparatus and the distance measuring unit.

17. The optical window inspection apparatus according to claim 9, wherein
the first light projector, the second light projector, the light receiver, and the control unit are housed in a first case body,
the reflector is housed in a second case body provided with the optical window,
the first case body is connected with the second case body, and
an inside of the first case body communicates with an inside of the second case body.

18. The optical window inspection apparatus according to claim 10, wherein
the first light projector, the second light projector, the light receiver, and the control unit are housed in a first case body,
the reflector is housed in a second case body provided with the optical window,
the first case body is connected with the second case body, and
an inside of the first case body communicates with an inside of the second case body.
